(19) United States
(12) Patent Application Publication
(10) Pub. No.: US 2007/0171606 A1
(43) Pub. Date: Jul. 26, 2007

(54) Information processing apparatus and power control method

(76) Inventor: Takashi Iwai, Hamura-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/650,694

(22) Filed: Jan. 8, 2007

(30) Foreign Application Priority Data
Jan. 26, 2006 (JP) 2006-017529

(51) Int. Cl. G06F 1/16

(52) U.S. Cl. 361/685

(57) ABSTRACT

According to one embodiment, an information processing apparatus includes a system unit, a first power supply unit which supplies a first operation power which drives the system unit by using power from a battery, a power supply controller which controls the first power supply unit in accordance with an operation of a power switch which is provided on a main body of the apparatus, thereby powering on/off the system unit, and a second power supply unit which supplies a second operation power which drives the power supply controller by using the power from the battery. The second power supply unit powers off the power supply controller by stopping the supply of the second operation power when the system unit is powered off and a display unit is closed.

### CROSS-REFERENCE TO RELATED APPLICATIONS

This application is based upon and claims the benefit of priority from Japanese Patent Application No. 2006-017529, filed Jan. 26, 2006, the entire contents of which are incorporated herein by reference.

### BACKGROUND

1. Field

One embodiment of the invention relates to an information processing apparatus such as a personal computer, and more particularly to an information processing apparatus which is drivable by a battery and a power control method for use in the apparatus.

2. Description of the Related Art

In recent years, various types of battery-drivable laptop or notebook portable computers have been developed. This kind of portable computer has a power supply controller for powering on/off a system unit of the computer in accordance with a user's operation of a power switch. Even in the state in which the system unit is shut down, that is, in the state in which the computer is powered off, the power supply controller is kept in a power-on state in order to enable the power supply controller to detect the user's operation of the power switch.

Thus, even in the state in which the system unit is shut down, an electric current of, e.g. about several-ten mA is consumed by the power supply controller. As a result, even when the system unit is shut down, the battery continues to be discharged.

Jpn. Pat. Appln. KOKAI Publication No. 2005-18740 discloses an electronic apparatus which has a function of powering off, at the time of system shut-down, not only the system unit, but also a micro-control unit which functions as a power supply controller.

Most of portable computers are configured to include a main body and a display unit which is freely openably attached to the main body. The user does works on the computer in the state in which the display unit is opened. When the computer is not used, the user closes the display unit.

Thus, in the power management of the portable computer, the open/closed state of the display unit needs to be considered in order to improve the operability of the computer.

In the electronic apparatus of the above-mentioned Jpn. Pat. Appln. KOKAI Publication No. 2005-18740, however, no consideration is given to the open/closed state of the display unit. At the time of system shut-down, the system unit and the micro-control unit are always powered off at the same time.

It is necessary, therefore, to realize a novel function of suppressing discharge of the battery, without degrading the operability of the computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the external appearance of an information processing apparatus according to an embodiment of the invention, which is viewed from the front side;

FIG. 2 is an exemplary perspective view showing an example of the external appearance of the information processing apparatus shown in FIG. 1 in the state in which a display unit is closed;

FIG. 3 is an exemplary block diagram showing an example of the system configuration of the information processing apparatus shown in FIG. 1;

FIG. 4 illustrates transition of power states of the information processing apparatus shown in FIG. 1;

FIG. 5 is an exemplary block diagram showing an example of the structure of a power supply circuit which is provided in the information processing apparatus shown in FIG. 1;

FIG. 6 shows an example of a hardware structure for controlling ON/OFF of standby power for use in the information processing apparatus shown in FIG. 1;

FIG. 7 shows an example of a setup screen for use in the information processing apparatus shown in FIG. 1;

FIG. 8 is an exemplary flow chart illustrating a part of the procedure of a power control process which is executed by the information processing apparatus shown in FIG. 1; and

FIG. 9 is an exemplary flow chart illustrating the other part of the procedure of the power control process which is executed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus which is drivable by a battery, includes: a main body; a display unit which is attached to the main body and is configured to be rotatable between a closed position where a top surface of the main body is covered by the display unit and an open position where the top surface of the main body is exposed; a system unit which is provided in the main body and executes various data processes; a first power supply unit which supplies a first operation power, which drives the system unit, to the system unit by using power from the battery; a power supply controller which is provided in the main body and controls the first power supply unit in accordance with an operation of a power switch which is provided on the main body, thereby powering on/off the system unit; and a second power supply unit which is provided in the main body and supplies a second operation power, which drives the power supply controller, to the power supply controller by using the power from the battery, the second power supply unit executing a power control process which powers off the power supply controller by stopping the supply of the second operation power to the power supply controller when the system unit is powered off and the display unit is closed.

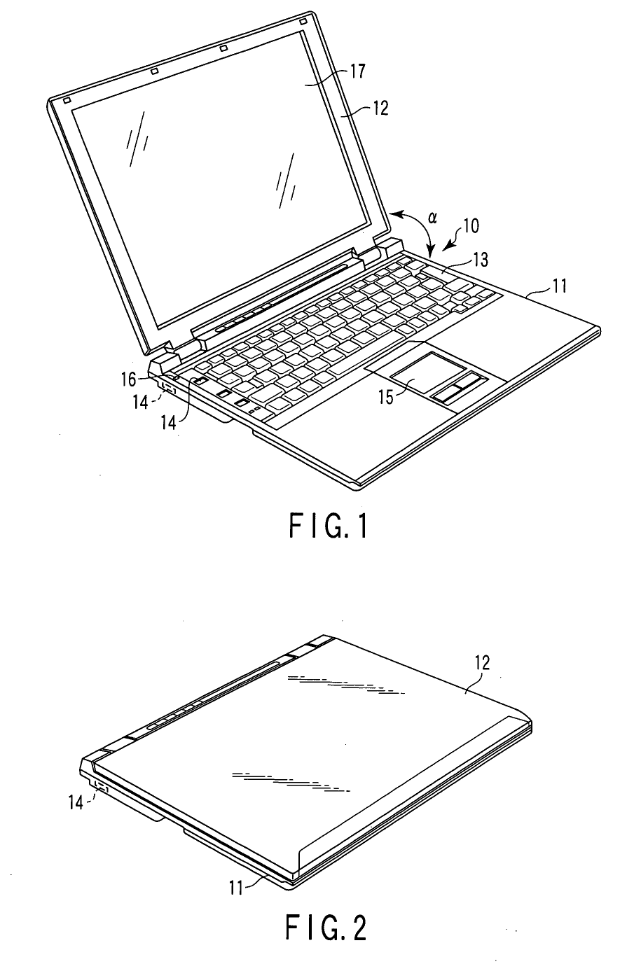

Referring to FIG. 1 and FIG. 2, the structure of an information processing apparatus according to the embodiment of the invention is described. The information processing apparatus is realized, for example, as a battery-drivable notebook-type portable personal computer 10.

FIG. 1 is a perspective view showing the computer 10, as viewed from the front side, in the state in which a display unit thereof is opened.

The computer 10 comprises a main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is attached to the main body 11 such that the display unit 12 is freely rotatable between an open position where a top surface of the main body 11 is exposed and a closed position where the top surface of the main body 11 is covered by the display unit 12. The main body 11 has a thin boxs-shaped casing in which a battery can detachably be attached. The battery is mounted in a battery receiving unit which is provided, for example, at a bottom surface of the main body 11.

A keyboard 13, a power switch 14 for powering on/off the computer 10, and a touch pad 15 are disposed on the top surface of the main body 11. A panel opening/closing detection switch 16 is provided, for example, on the top surface of the main body 11. The panel opening/closing detection switch 16 is a detection switch for detecting whether the display unit 12 is closed or opened. The panel opening/closing detection switch 16 may be composed of, e.g. a push-button switch or a rotational angle sensor.

If the angle α between the surface of the display unit 12 and the top surface of the main body 11 decreases to a predetermined value or less, the panel opening/closing detection switch 16 detects that the display unit 12 is closed. On the other hand, if the angle α exceeds the predetermined value, the panel opening/closing detection switch 16 detects that the display unit 12 is opened.

The main body 11 includes a system unit which executes various data processes, and a power supply controller which powers on/off the system unit in accordance with the user's operation of the power switch 14.

In the state in which the display unit 12 is opened, even if the computer 10 is shut down, that is, even if the system unit is powered off, the power supply controller is kept in the power-on state. Thus, in the state in which the display unit 12 is opened, the power supply controller is always in the active state and can detect the user's operation of the power switch 14. In other words, in the state in which the display unit 12 is opened, the power supply controller can power on/off the system unit in accordance with the user's operation of the power switch 14.

FIG. 2 is a perspective view showing the external appearance of the computer 10 in the state in which the display unit 12 is closed.

In the state in which the display unit 12 is closed, the keyboard 13, power switch 14 and touch pad 15 are covered by the display unit 12. Thus, in the state in which the display unit 12 is closed, the user cannot use the computer 10.

As described above, if the computer 10 is shut down, only the system unit is powered off, and the power supply controller is kept in the power-on state. In this state, if the display unit 12 is closed by the user, the power supply controller is powered off. Thereby, the battery power is not consumed by the power supply controller, and the discharge of the battery can greatly be suppressed.

Even if the computer 10 is shut down, the power supply controller is kept in the power-on state unless the display unit 12 is closed. Accordingly, while the display unit 12 is opened, the power supply controller can accept the user's operation of the power switch 14. Thus, in the state in which the display unit 12 is opened, even after the computer 10 is shut down, the user can activate the computer 10 only by operating the power switch.

If the display unit 12 is opened in the state in which the power supply controller is powered off, only the power supply controller is automatically powered on in the state in which the system unit is powered off. Thereby, the power supply controller can accept the user's operation of the power switch 14.

It is not necessary that the power switch 14 be provided on the top surface of the main body 11. The power switch 14 may be provided at a predetermined position on the main body, for example, on a side surface of the main body 11, which is always exposed to the outside regardless of the open/closed state of the display unit 12.

In the case where the power switch 14 is provided, for example, on the side surface of the main body 11, the power switch 14 may possibly be pressed by external stress in such a situation that the computer 10 is put in the user's bag. However, since the power supply controller is powered off in the state in which the display unit 12 is closed, the computer 10 is never powered on even if the power switch 14 is pressed by external stress.

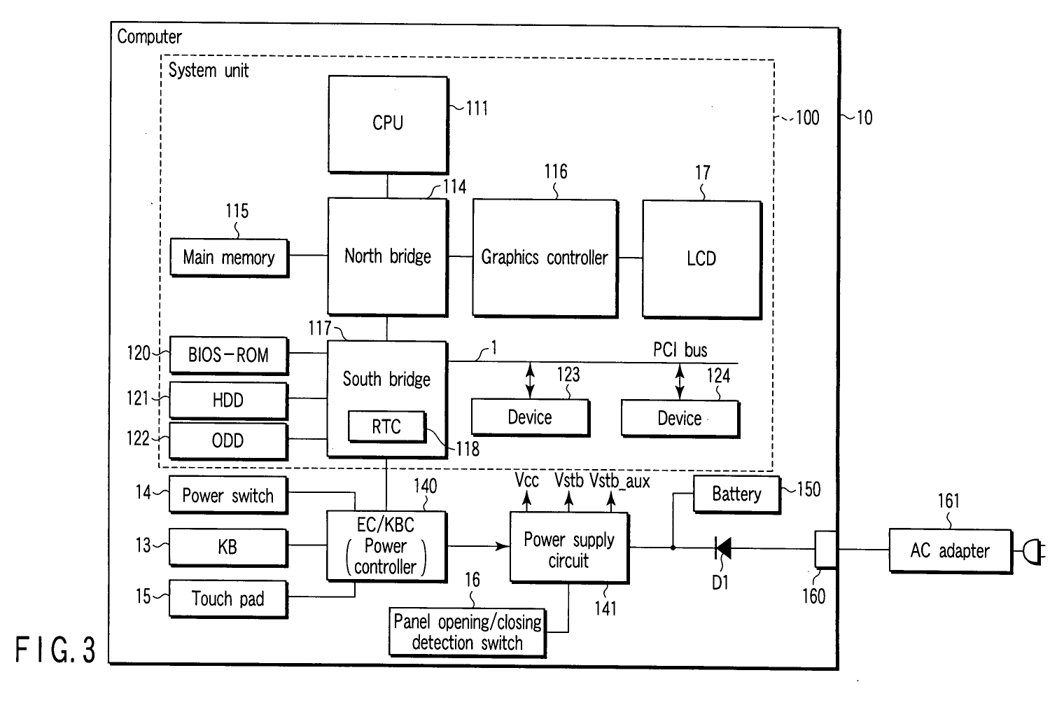

FIG. 3 shows an example of the system configuration of the computer 10.

The computer 10 comprises a CPU 111, a north bridge 114, a main memory 115, a graphics controller 116, a south bridge 117, a BIOS-ROM 120, a hard disk drive (HDD) 121, an optical disc drive (ODD) 122, various PCI devices 123, 124, an embedded controller/keyboard controller IC (EC/KBC) 140, and a power supply circuit 141.

A system unit 100 is composed of, for example, the CPU 111, north bridge 114, main memory 115, graphics controller 116, south bridge 117, BIOS-ROM 120, hard disk drive (HDD) 121, optical disc drive (ODD) 122, and various PCI devices 123, 124.

The CPU 111 is a processor that is provided for controlling the operation of the computer 10. The CPU 111 executes an operating system and various application programs, which are loaded in the main memory 115 from the HDD 121. The CPU 111 also executes a system BIOS (Basic Input/Output System) that is stored in the BIOS-ROM 120. The system BIOS is a program for hardware control.

The north bridge 114 is a bridge device that connects a local bus of the CPU 111 and the south bridge 117. The north bridge 114 includes a memory controller that access-controls the main memory 115. The north bridge 114 has a function of executing communication with the graphics controller 116 via, e.g. a PCI Express bus.

The graphics controller 116 is a display controller for controlling the LCD 17 that is used as a display monitor of the computer 10. The graphics controller 116 includes a video memory and generates a video signal, which forms a display image to be displayed on the LCD 17, on the basis of display data that is written in the video memory by the OS/application program.

The south bridge 117 is connected to a PCI bus 1 and executes communication with the PCI devices 123 and 124 via the PCI bus 1. The south bridge 117 includes an IDE (Integrated Drive Electronics) controller or a Serial ATA controller for controlling the hard disk drive (HDD) 121 and optical disc drive (ODD) 122. Further, the south bridge 117 includes a real-time clock (RTC) 118. The real-time clock (RTC) 118 is a clock module which measures a present time (year, month, date, hour, minute, second).

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 functions as the power supply controller which powers on/off the computer 10, that is, the system unit 100, in response to the user's operation of the power switch 14. The control for powering on/off the system unit 100 is executed by cooperation of the EC/KBC 140 and power supply circuit 141.

The power supply circuit 141 uses power from a battery 150 which is mounted in the computer main body 11 or power (external power) from an AC adapter 161 which is connected to the computer main body 11 as an external power supply device, thereby generating operational powers to the respective components. The AC adapter 161 is connected, as needed, to an external power supply connection terminal 160 which is provided on the computer main body 11. The external power supply connection terminal 160 is connected to the power supply circuit 141 via a backflow prevention diode D1.

In the computer 10, the power supply circuit 141 generates three kinds of operation powers: system power (also referred to as “system power supply voltage”) Vcc, standby power (also referred to as “standby power supply voltage”) Vstb, and auxiliary standby power (also referred to as “auxiliary standby power supply voltage”) Vstb_aux. The system power Vcc is an operation power (first operation power) for driving the system unit 100, and is supplied to the respective components in the system unit 100. The standby power Vstb is an operation power (second operation power) for driving the EC/KBC (power supply controller) 140 and its peripheral circuits. In the state in which the display unit 12 is opened, the standby power Vstb is always supplied to the EC/KBC 140. If the supply of system power Vcc to the system unit 100 is stopped and the display unit 12 is closed, the supply of standby power Vstb to the EC/KBC 140 is stopped. Thereby, the EC/KBC 140 is powered off. If the display unit 12 is opened in the state in which the EC/KBC 140 is powered off, the supply of the standby power Vstb to the EC/KBC 140 is resumed and the EC/KBC 140 is powered on. The auxiliary standby power Vstb_aux is an operation power for driving the real-time clock (RTC) 118, etc.

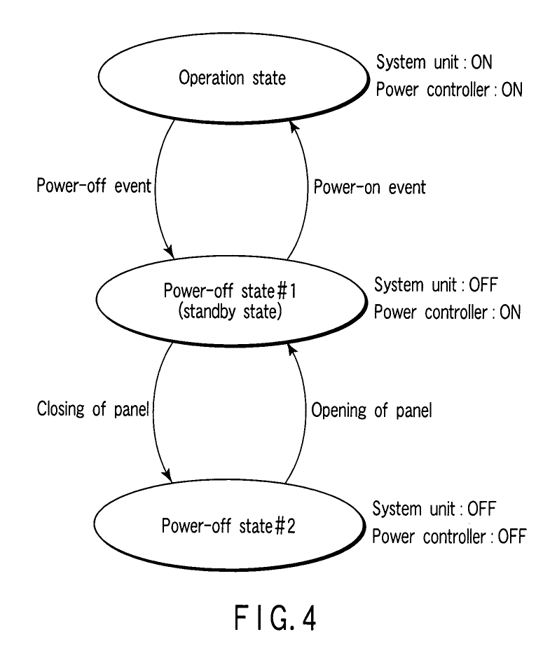

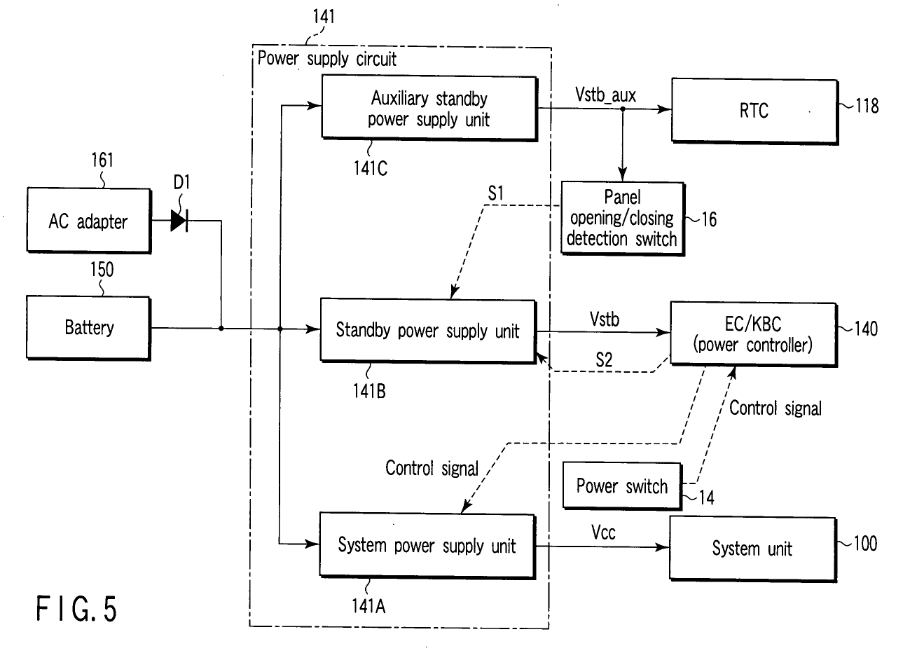

Next, referring to FIG. 4, the transition of power states of the computer 10 is described.

The computer 10 is set in any one of the following power states:

(1) operation state,

(2) power-off state #1, and

(3) power-off state #2.

The operation state is a power state in which both the system unit 100 and EC/KBC 140 are powered on.

In the operation state, if a power-off event, such as the user's operation of the power switch 14, occurs, the EC/KBC 140 controls the power supply circuit 141 and turns off the system power Vcc. Thereby, the system unit 100 is powered off in the state in which the EC/KBC 140 is powered on. Thus, the power state of the computer 10 transitions from the operation state to the power-off state #1.

The power-off state #1 is a power state in which the system unit 100 is powered off and the EC/KBC 140 is powered on.

In the power-off state #1, if a power-on event, such as the user's operation of the power switch 14, occurs, the EC/KBC 140 controls the power supply circuit 141 and turns on the system power Vcc. Thereby, the system unit 100 is powered on. Thus, the power state of the computer 10 transitions from the power-off state #1 to the operation state.

In the power-off state #1, if the display panel 12 is closed by the user, the standby power Vstb is turned off. Thereby, the EC/KBC 140 is powered off. Thus, the power state of the computer 10 transitions from the power-off state #1 to the power-off state #2.

The power-off state #2 is a power state in which each of the system unit 100 and EC/KBC 140 is powered off.

In the power-off state #2, if the display panel 12 is opened by the user, the standby power Vstb is turned on. Thereby, the EC/KBC 140 is powered on in the state in which the system unit 100 is powered off. Thus, the power state of the computer 10 transitions from the power-off state #2 to the power-off state #1.

Next, referring to FIG. 5, the structure of the power supply circuit 141 is described.

The power supply circuit 141, as shown in FIG. 5, includes three, first to third power supply units, that is, a system power supply unit 141A, a standby power supply unit 141B and an auxiliary standby power supply unit 141C.

The system power supply unit 141A is a first power supply unit which outputs the system power Vcc. The system power supply unit 141A uses power from the battery 150 or power (external power) from the AC adapter 161, thereby generating the system power Vcc and supplying the system power Vcc to the respective components of the system unit 100. The system power supply unit 141A controls ON/OFF of the system power Vcc in accordance with the control signal from the EC/KBC 140.

The standby power supply unit 141B is a second power supply unit which outputs the standby power Vstb. The standby power supply unit 141B uses power from the battery 150 or power (external power) from the AC adapter 161, thereby generating the standby power Vstb and supplying the standby power Vstb to the EC/KBC 140, etc. When the system unit 100 is powered off and the display unit 12 is closed, the standby power supply unit 141B stops the supply of the standby power Vstb to the EC/KBC 140 and powers off the EC/KBC 140. In addition, if the display unit 12 is opened in the state in which the EC/KBC 140 is powered off, the standby power supply unit 141B supplies the standby power Vstb to the EC/KBC 140 and powers on the EC/KBC 140.

The ON/OFF control of the standby power Vstb is executed on the basis of a detection signal S1 from the panel opening/closing detection switch 16 and a control signal S2 from the EC/KBC 140. The detection signal S1 is indicative of opening/closing of the display unit 12. If the display unit 12 is closed, the panel opening/closing detection switch 16 outputs a low-level detection signal S1. If the display unit 12 is opened, the panel opening/closing detection switch 16 outputs a high-level detection signal S1.

The control signal S2 instructs permission or prohibition of the execution of a power control process for turning off the standby power Vstb in response to the closing of the display unit 12. For example, if the system unit 100 is powered off, the EC/KBC 140 outputs a low-level control signal S2 which indicates permission of the execution of the power control process. If the system unit 100 is in the power-on state, the EC/KBC 140 outputs a high-level control signal S2 which indicates prohibition of the execution of the power control process. Thereby, in the above-described operation state in which the system unit 100 is powered on, even if the display unit 12 is closed, the standby power Vstb is never turned off. In addition, in a suspend state (i.e. a state in which system data necessary for recovery of a working state of the system unit 100 is saved and almost all the system components in the system unit 100, other than the main memory 115, are powered off), the EC/KBC 140 outputs the high-level control signal S2 which indicates prohibition of the execution of the power control process.

Also in the case where external power is supplied to the main body 11, the EC/KBC 140 outputs the high-level control signal S2 which indicates prohibition of the execution of the power control process. When the control signal S2 is at high level, even if the display unit 12 is closed, the standby power Vstb is not turned off.

The auxiliary standby power supply unit 141C is a third power supply unit which outputs the auxiliary standby power Vstb_aux. The auxiliary standby power supply unit 141C uses power from the battery 150 or power (external power) from the AC adapter 161, thereby generating the auxiliary standby power Vstb_aux and supplying the auxiliary standby power Vstb_aux to the RTC 118, etc. The auxiliary standby power Vstb_aux is always kept in the ON state, regardless of the opening/closing of the display unit 12.

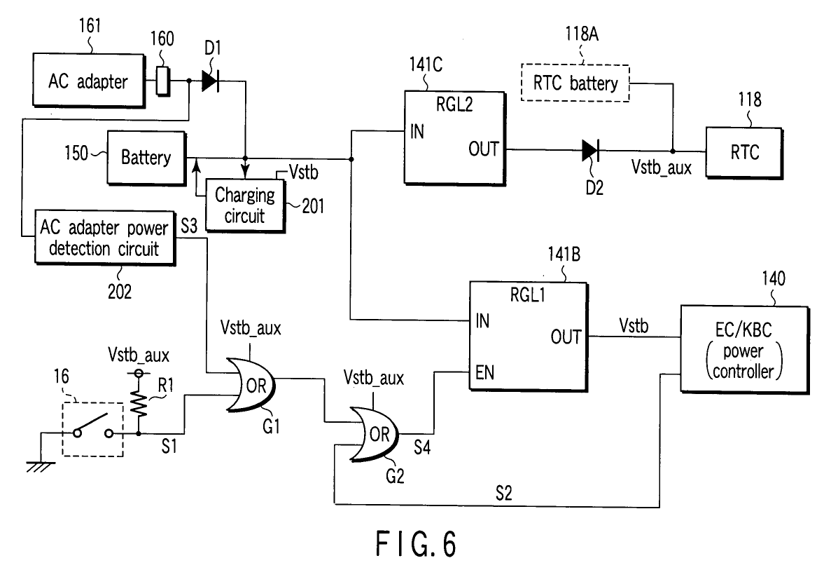

Next, referring to FIG. 6, a specific example of the hardware structure for controlling the ON/OFF of the standby power Vstb is described.

In FIG. 6, for the purpose of simple description, the standby power supply unit 141B is depicted as a single regulator (RGL1) and the auxiliary standby power supply unit 141C is also depicted as a single regulator (RGL2).

A charging circuit 201 is connected to an output stage of the battery 150. The charging circuit 201 is driven by the standby power Vstb from the standby power supply unit 141B. The charging circuit 201 charges the battery 160 by using external power from the AC adapter 161.

An AC adapter power detection circuit 202 is an external power detection unit which determines whether external power is supplied to the main body 11. The AC adapter power detection circuit 202 determines whether external power is supplied to the main body 11 or not, for example, by monitoring the potential of a connection node between the external power supply connection terminal 160 and the backflow prevention diode Dl. An output signal S3 from the AC adapter power detection circuit 202 is at a high level when the external power is supplied to the main body 11, and is at a low level when the external power is not supplied to the main body 11. The output signal S3 is delivered to one of two inputs of a 2-input OR gate Gl. The 2-input OR gate Gl is driven by the auxiliary standby power Vstb_aux.

The detection signal S1 from the panel opening/closing detection switch 16 is delivered to the other input of the 2-input OR gate Gl. One end of a pull-up resistor R1 is connected to the output terminal of the panel opening/closing detection switch 16. The auxiliary standby power Vstb_aux is supplied to the other end of the pull-up resistor R1.

When the display unit 12 is closed, the panel opening/closing detection switch 16 is turned on and thus the detection signal S1 is set at the low level. When the display unit 12 is opened, the panel opening/closing detection switch 16 is turned off and thus the detection signal S1 is set at the high level.

An output signal from the 2-input OR gate G1 is supplied to one of two inputs of a 2-input OR gate G2. The 2-input OR gate G2 is driven by the auxiliary standby power Vstb_aux. The control signal S2 from the EC/KBC 140 is delivered to the other input of the 2-input OR gate G2. The control signal S2, as described above, is the signal for permitting or prohibiting the execution of the power control process. In the state in which the system unit 100 is powered on, or in the suspend state, the EC/KBC 140 outputs the high-level control signal S2. When the system unit 100 is shut down, the EC/KBC 140 outputs the low-level control signal S2 if system setup information indicates “battery discharge suppression mode=ENABLE”, and outputs the high-level control signal S2 if the system setup indicates “battery discharge suppression mode=DISABLE”.

An output signal S4 of the 2-input OR gate G2 is supplied to an enable terminable (EN) of the standby power supply unit 141B. When the output signal S4 of the 2-input OR gate G2 is at high level, the standby power supply unit 141B outputs the standby power Vstb. When the output signal S4 of the 2-input OR gate G2 is at low level, the standby power supply unit 141B stops the output of the standby power Vstb

The output signal S4 is given by the following equation:

S1 ∪ S2 ∪ S3=S4.

In the equation, ∪ represents a union (i.e. “or”).

Specifically, the output signal S4 is at a low level when the display unit 12 is closed (S1=low level) in the state in which the external power is not supplied to the main body 11 (S3=low level) and the execution of the power control process is permitted (S2=low level).

The auxiliary standby power supply unit 141C is always kept in the ON state (the enable terminal EN of the auxiliary standby power supply unit 141C is fixed at high level).

An RTC battery 118A which supplies operation power to the RTC 118 may be provided.

A description is given of the operation in the case where the computer 10 is shut down in the state in which “battery discharge suppression mode=ENABLE” is set.

If the power switch 14 is operated by the user in the state in which “battery discharge suppression mode=ENABLE” is set, the system unit 100 is powered off. In response to the power-off of the system unit 100, the control signal S2 changes from the high level to the low level.

In the case where the AC adapter 161 is not connected to the main body 11, the detection signal S3 is at low level. Thus, if the user closes the display panel 12, all the signals S1, S2 and S3 are set at the low level, and thereby the signal S4 is set at the low level. Consequently, the standby power Vstb is turned off. Thereby, the discharge of the battery 150 can greatly be reduced.

On the other hand, in the case where the AC adapter 161 is connected to the main body 11, the detection signal S3 is at high level. Thus, even if the user closes the display panel 12, the signal S4 is kept at the high level, and the standby power Vstb is not turned off. Hence, the charging circuit 201 can be operated, and the battery 150 can be charged by using the external power from the AC adapter 161 even while the display panel 12 is closed.

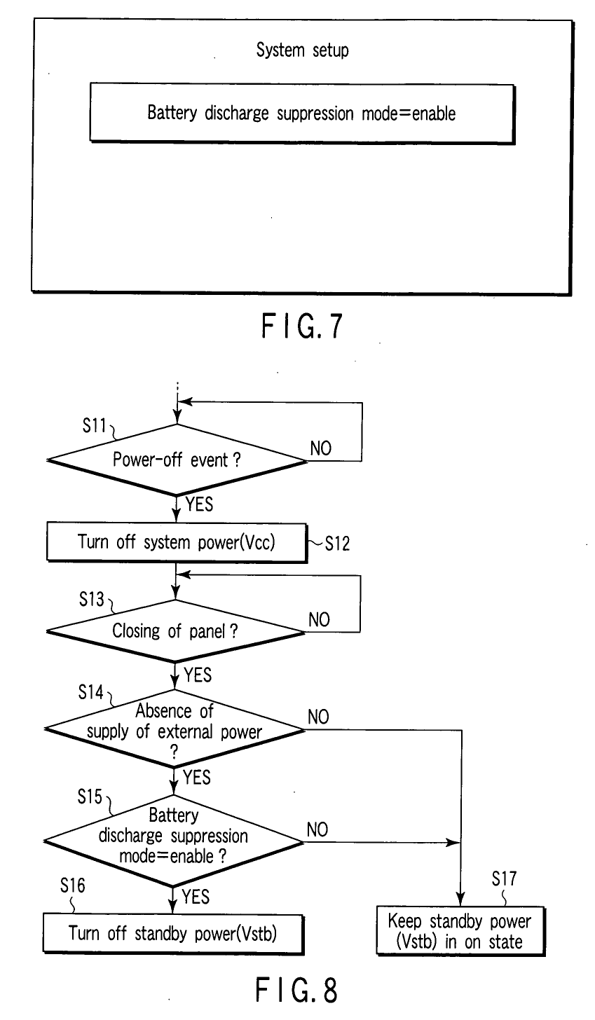

FIG. 7 shows an example of a setup screen for prompting the user to set the “battery discharge suppression mode”.

This setup screen is displayed on the LCD 20, for example, by the BIOS. If the user sets “battery discharge suppression mode=ENABLE”, the BIOS stores mode information, which designates effectiveness of the power control process, in a storage unit such as BIOS-ROM 120. On the other hand, if the user sets “battery discharge suppression mode=DISABLE”, the BIOS stores mode information, which designates non-effectiveness of the power control process, in the storage unit such as BIOS-ROM 120.

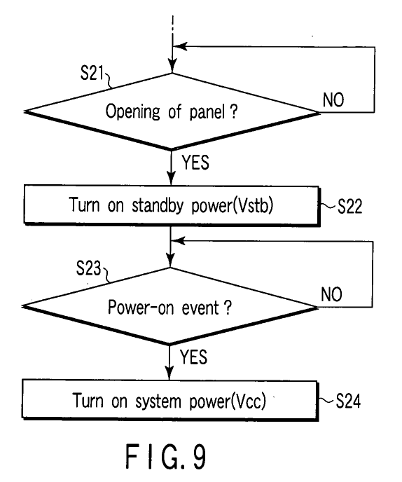

Next, referring to flow charts of FIG. 8 and FIG. 9, the procedure of the power control process for suppressing the discharge of the battery 140 is described.

If a power-off event, such as the user's operation of the power switch 14, occurs in the state in which the system unit 100 is powered on (YES in step S11), the EC/KBC 140 controls the system power supply unit 141A and stops the supply of the system power Vcc to the system unit 100 (step S12). Thereby, the system unit 100 is powered off. The EC/KBC 140 is kept in the power-on state.

Then, if the display unit 12 is closed by the user (YES in step S13) and if the two conditions of “absence of supply of external power” and “battery discharge suppression mode=ENABLE” are satisfied, the standby power supply unit 141B executes the power control process of stopping the supply of the standby power Vstb to the EC/KBC 140 and powering off the EC/KBC 140 (step S16). Specifically, if the two conditions of “absence of supply of external power” and “battery discharge suppression mode=ENABLE” are satisfied, the signals S3 and S2 are set as follows: the signal S3=low level and the signal S2=low level. Thus, the standby power supply unit 141B stops the supply of the standby power Vstb to the EC/KBC 140 in response to the change from the high level to the low level of the signal S1 from the panel opening/closing detection switch 16.

Whether the condition of “absence of supply of external power” is satisfied or not is determined by the AC adapter power detection circuit 202. In addition, the EC/KBC 140 refers to the mode information that is stored in the storage unit, thereby to determine whether the condition of “battery discharge suppression mode=ENABLE” is satisfied or not.

If one of the above two conditions is not satisfied, the standby power supply unit 141B prohibits the execution of the power control process, thereby keeping the standby power Vstb in the ON state (step S17).

If the display panel 12 is opened by the user in the state in which the EC/KBC 140 is powered off (YES in step S21 in FIG. 9), the signal S1 from the panel opening/closing detection switch 16 changes from the low level to the high level. Responding to the change from the low level to the high level of the signal S1, the standby power supply unit 141B supplies the standby power Vstb to the EC/KBC 140 and powers on the EC/KBC 140 (step S22). Thereby, the EC/KBC 140 can detect the user's operation of the power switch 14.

If the power-on event, such as the user's operation of the power switch 14, occurs (YES in step S23), the EC/KBC 140 controls the system power supply unit 141A and turns on the system power Vcc (step S24). Thereby, the system unit 100 is powered on.

In the case of an ordinary computer, even if the computer is shut down, the power supply controller is always kept in the power-on state and the discharge of the battery always occurs.

By contrast, in the case of the computer 10 according to the present embodiment, if the computer 10 is shut down, the system unit 100 is first powered off. Further, if the display unit 12 is closed, the power supply controller (EC/KBC 140) is also powered off. Thus, in the state in which the computer 10 is shut down and the display unit 12 is closed, the discharge of the battery can be suppressed. During the time period in which the display unit 12 is closed, the user's operation of the power switch 14 cannot be accepted. In normal cases, however, the user does not use the computer 10 while the display unit 12 is closed, so the operability is not degraded. If the display unit 12 is opened, the power supply controller (EC/KBC 140) is automatically powered on, and the user's operation of the power switch 14 can be accepted.

Therefore, the discharge of the battery 150 can be suppressed without degrading the operability of the computer 10.

In the meantime, the discharge of the battery can be prevented by removing the battery itself from the main body 11. Compared to this method, however, the present embodiment has the following advantages.

(1) A work of removing the battery is needless, and a work of managing the removed battery is also needless.

(2) The discharge of the RTC battery can be prevented.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus which is drivable by a battery, comprising:
a main body;
a display unit which is attached to the main body and is configured to be rotatable between a closed position where a top surface of the main body is covered by the display unit and an open position where the top surface of the main body is exposed;
a system unit which is provided in the main body and executes various data processes;
a first power supply unit which supplies a first operation power, which drives the system unit, to the system unit by using power from the battery;
a power supply controller which is provided in the main body and controls the first power supply unit in accordance with an operation of a power switch which is provided on the main body, thereby powering on/off the system unit; and
a second power supply unit which is provided in the main body and supplies a second operation power, which drives the power supply controller, to the power supply controller by using the power from the battery, the second power supply unit executing a power control process which powers off the power supply controller by stopping the supply of the second operation power to the power supply controller when the system unit is powered off and the display unit is closed.

2. The information processing apparatus according to claim 1, wherein the second power supply unit supplies the second operation power to the power supply controller when the display unit is opened in a state in which the power supply controller is powered off, thereby powering on the power supply controller.

3. The information processing apparatus according to claim 1, further comprising an external power detection unit which determines whether external power is supplied to the main body,
wherein the second power supply unit prohibits the execution of the power control process in a case where the external power is supplied to the main body.

4. The information processing apparatus according to claim 1, further comprising a storage unit which stores mode information which designates effectiveness or non-effectiveness of the power control process,
wherein the second power supply unit prohibits the execution of the power control process in a case where the mode information stored in the storage unit indicates the non-effectiveness of the power control process.

5. The information processing apparatus according to claim 1, further comprising:
an external power detection unit which determines whether external power is supplied to the main body; and
a charging circuit which is driven by the second operation power and charges the battery by using the external power,
wherein the second power supply unit prohibits the execution of the power control process in a case where the external power is supplied to the main body.

6. An information processing apparatus which is drivable by a battery, comprising:
a main body;
a display unit which is attached to the main body and is configured to be rotatable between a closed position where a top surface of the main body is covered by the display unit and an open position where the top surface of the main body is exposed;
a system unit which is provided in the main body and executes various data processes;
a first power supply unit which supplies a first operation power, which drives the system unit, to the system unit by using power from the battery;
a power supply controller which is provided in the main body and controls the first power supply unit in accordance with an operation of a power switch which is provided on the main body, thereby powering on/off the system unit; and
a second power supply unit which is provided in the main body and supplies a second operation power, which drives the power supply controller, to the power supply controller by using the power from the battery when the display unit is opened in a state in which the system unit and the power supply controller are powered off, thereby powering on the power supply controller.

7. The information processing apparatus according to claim 6, wherein the second power supply unit powers off the power supply controller by stopping the supply of the second operation power to the power supply controller when the system unit is powered off and the display unit is closed.

8. A power control method for reducing power consumption of an information processing apparatus which is drivable by a battery, comprising:
powering off, in accordance with an operation of a power switch which is provided on a main body of the information processing apparatus, a system unit, which is provided in the main body, in a state in which a power supply controller which is provided in the main body is kept in a power-on state, the power supply controller being configured to power on/off the system unit in accordance with the operation of the power switch, the system unit being configured to execute various data processes; and
executing a power control process which powers off the power supply controller when a display unit which is attached to the main body is closed in a state in which the system unit is powered off, the display unit being configured to be rotatable between a closed position where a top surface of the main body is covered by the display unit and an open position where the top surface of the main body is exposed.

9. The power control method according to claim 8, further comprising powering on the power supply controller when the display unit is opened in a state in which the power supply controller is powered off.

10. The power control method according to claim 8, further comprising:
determining whether external power is supplied to the main body; and
prohibiting the execution of the power control process in a case where it is determined that the external power is supplied to the main body.

11. The power control method according to claim 8, wherein the information processing apparatus further comprises a storage unit which stores mode information which designates effectiveness or non-effectiveness of the power control process, and
the power control method further comprises prohibiting the execution of the power control process in a case where the mode information stored in the storage unit indicates the non-effectiveness of the power control process.
